(19) United States
(12) Patent Application Publication
(10) Pub. No.: US 2011/0109184 A1
(43) Pub. Date: May 12, 2011

(54) TANDEM ROTOR SERVO MOTOR

(76) Inventor: Gerald K. Langreck, Phillips, WI (US)

(21) Appl. No.: 12/944,834

(22) Filed: Nov. 12, 2010

Related U.S. Application Data
(60) Provisional application No. 61/280,944, filed on Nov. 12, 2009.

(51) Int. Cl. H02K 16/00

(52) U.S. Cl. 310/114

(57) ABSTRACT

A tandem rotor servo motor assembly is provided comprising a first phase element positioned on a shaft, the first phase element having a first rotor in communication with the shaft and surrounded by a stator carrying four magnetic poles, each of said poles exerting a magnetic force when said poles are electrically charged. A second phase element is positioned on the shaft a first distance from the first phase element, the second phase element having a second rotor in communication with the shaft and surrounded by a stator carrying four magnetic poles, each of said poles exerting a magnetic force when said poles are electrically charged. A third phase element is positioned on the shaft a second distance from the second phase element, the third phase element having a third rotor in communication with the shaft and surrounded by a stator carrying four magnetic poles, each of said poles exerting a magnetic force when said poles are electrically charged. The second rotor is offset about the shaft from the first rotor by sixty degrees of rotation and the third rotor being offset about the shaft from the first rotor by one hundred and twenty degrees of rotation.

### CROSS-REFERENCE TO RELATED APPLICATIONS

This application claims priority from U.S. Provisional Application Ser. No. 61/280,944, filed Nov. 12, 2009, entitled TANDEM ROTOR SERVO MOTOR AND ELECTRONIC DRIVE METHODS, the contents of which is hereby incorporated in its entirety by reference.

### FIELD OF THE INVENTION

The present invention relates to a tandem servo motor assembly. The present invention more specifically relates to a tandem servo motor assembly generating high torque at a reduced inertia and providing a smooth, ripple free torque operation.

### BACKGROUND

Servo motors are generally known in the art. A servo motor is an electromechanical device in which an electrical input determines a mechanical output, for example the rotational velocity and torque of a corresponding motor shaft. A multi-phase servo motor generally includes a rotor surrounded by a nonmoving stator. Windings, or coils of wire, are positioned on the stator. Electrical currents of differing phase are provided to the windings, producing a rotating magnetic field. The rotating magnetic field interacts with the rotor, causing the rotor to turn. The electrical current is generally provided by a drive. The drive can control the amount of electrical current transmitted to the motor, correspondingly controlling the rotation of the motor shaft. Such drives may be referred to as variable-speed or variable-frequency drives.

It is desired for some end uses of a servo motor to have a high torque to low inertia ratio. A servo motor having a high torque to low inertia ratio provides a fast rate of acceleration of the motor rotor. However, multi-phase servo motors as described above have limitations on the torque to inertia ratio, especially in applications requiring a larger sized motor. This is due to the larger, higher weight motor and components necessary to rotate a rotor at higher speeds or revolutions per minute (RPM).

In addition, it is desired for servo motors to operate with a smooth torque output, minimizing the amount of ripple torque, also known as torque ripple. Torque ripple is a fluctuation in torque delivered by a motor due to electromechanical effects. Torque ripple results in unwanted pulsations which can increase in strength and frequency at higher motor and/or rotor speeds. A source of torque ripple in a multi-phase servo motor occurs when the torque per amp of a phase shifts, or moves out of phase in association with the other phases. In situations where a phase shifts, torque ripple can be reduced or minimized by improving the torque constant of a motor. Multi-phase servo motors as described above generally have a trapezoidal shaped torque constant. Accordingly, should a phase shift in a multi-phase servo motor as described above, torque ripple will occur.

Accordingly, an improved servo motor assembly and method of driving a servo motor is provided.

### SUMMARY OF THE INVENTION

A tandem rotor servo motor assembly is provided comprising a first phase element positioned on a shaft, the first phase element having a first rotor in communication with the shaft and surrounded by a stator carrying four magnetic poles, each of said poles exerting a magnetic force when said poles are electrically charged. A second phase element is positioned on the shaft a first distance from the first phase element, the second phase element having a second rotor in communication with the shaft and surrounded by a stator carrying four magnetic poles, each of said poles exerting a magnetic force when said poles are electrically charged. A third phase element is positioned on the shaft a second distance from the second phase element, the third phase element having a third rotor in communication with the shaft and surrounded by a stator carrying four magnetic poles, each of said poles exerting a magnetic force when said poles are electrically charged. The second rotor is offset about the shaft from the first rotor by sixty degrees of rotation and the third rotor being offset about the shaft from the first rotor by one hundred and twenty degrees of rotation.

In another embodiment of a tandem rotor servo motor assembly, the assembly comprises a multi-phase servo motor having a first phase element, a second phase element, and a third phase element, the first, second and third phase elements including a rotor and a stator carrying four magnetically charged poles, each pole exerting a magnetic force when said poles are electrically charged. A shaft is connected to the rotors of the first, second and third phase elements, the second rotor is provided on the shaft π/3 radians offset from the first rotor, and the third rotor is provided on the shaft 2π/3 radians offset from the first rotor.

In another embodiment of a tandem servo motor, the motor comprises a first phase element in communication with a shaft, the first phase element having a first rotor connected to the shaft and surrounded by a stator carrying four magnetic poles, each of said poles exerting a magnetic force when said poles are electrically charged by a first phase of a three-phase current, said first phase element producing a square waveform torque constant. A second phase element is in communication with the shaft a first distance from the first phase element, the second phase element having a second rotor connected to the shaft and surrounded by a stator carrying four magnetic poles, each of said poles exerting a magnetic force when said poles are electrically charged by a second phase of a three-phase current, said second phase element producing a square waveform torque constant. A third phase element in communication with the shaft a second distance from the second phase element and a third distance from the first phase element, the third phase element having a third rotor connected to the shaft and surrounded by a stator carrying four magnetic poles, each of said poles exerting a magnetic force when said poles are electrically charged by a third phase of a three-phase current, said third phase element producing a square waveform torque constant. The second rotor is offset about the shaft from the first rotor by approximately sixty degrees of rotation and the third rotor is offset about the shaft from the first rotor by approximately one hundred and twenty degrees of rotation and from the second rotor by approximately sixty degrees of rotation.

### BRIEF DESCRIPTION OF THE DRAWINGS

FIG. 1 is a plan view according to one or more examples of embodiments of a tandem rotor servo motor assembly, showing the rotor and stator assemblies.

FIG. 2 is a cross-sectional view of a section of the tandem rotor servo motor assembly of FIG. 1, showing a first phase tandem motor element taken along line 2-2 of FIG. 1.

FIG. 3 is a graph showing the torque per amp versus rotor angle for one revolution of the rotor of the first phase tandem motor element of FIG. 2.

FIG. 4 is a cross-sectional view of a section of the tandem rotor servo motor assembly of FIG. 1, showing a second phase tandem motor element taken along line 4-4 of FIG. 1.

FIG. 5 is a graph showing the torque per amp versus rotor angle for one revolution of the rotor of the second phase tandem motor element of FIG. 4.

FIG. 6 is a cross-sectional view of a section of the tandem rotor servo motor assembly of FIG. 1, showing a third phase tandem motor element taken along line 6-6 of FIG. 1.

FIG. 7 is a graph showing the torque per amp versus rotor angle for one revolution of the rotor of the third phase tandem motor element of FIG. 6.

FIG. 8 is a plan view according to one or more examples of embodiments of the tandem rotor servo motor assembly of FIG. 1, showing the rotor and stator assemblies.

FIG. 9 is a cross-sectional view of a section of the tandem rotor servo motor assembly of FIG. 8, showing a first phase tandem motor element taken along line 9-9 of FIG. 8.

FIG. 10 is a graph showing the torque per amp versus rotor angle for one revolution of the rotor of the first phase tandem motor element of FIG. 9.

FIG. 11 is a cross-sectional view of a section of the tandem rotor servo motor assembly of FIG. 8, showing a second phase tandem motor element taken along line 11-11 of FIG. 8.

FIG. 12 is a graph showing the torque per amp versus rotor angle for one revolution of the rotor of the second phase tandem motor element of FIG. 11.

FIG. 13 is a cross-sectional view of a section of the tandem rotor servo motor assembly of FIG. 8, showing a third phase tandem motor element taken along line 13-13 of FIG. 8.

FIG. 14 is a graph showing the torque per amp versus rotor angle for one revolution of the rotor of the third phase tandem motor element of FIG. 13.

FIG. 15 is a cross-sectional view according to one or more examples of embodiments of a tandem rotor servo motor assembly lamination.

FIG. 16 is a plan view of the tandem rotor servo motor assembly of FIG. 8, illustrating placement of one or more laminations.

FIG. 17 is a plan view of one or more examples of embodiments of a tandem rotor servo motor assembly of FIG. 1, illustrating placement of one or more laminations.

FIG. 18 is a graph showing the torque per amp versus rotor angle for one revolution of a rotor of a first phase or A phase of a conventional single rotor, single stator three-phase motor.

FIG. 19 is a graph showing the torque per amp versus rotor angle for one revolution of a rotor of a second phase or B phase of a conventional single rotor, single stator three-phase motor.

FIG. 20 is a graph showing the torque per amp versus rotor angle for one revolution of a rotor of a third phase or C phase of a conventional single rotor, single stator three-phase motor.

FIG. 21 is a graph showing the torque per amp versus rotor angle for one revolution of the rotor of the first phase or A phase tandem motor element of FIG. 9 driven by a square wave current provided from a drive.

FIG. 22 is a graph showing the torque per amp versus rotor angle for one revolution of the rotor of the second phase or B phase tandem motor element of FIG. 11 driven by a square wave current provided from a drive.

FIG. 23 is a graph showing the torque per amp versus rotor angle for one revolution of the rotor of the third phase or C phase tandem motor element of FIG. 13 driven by a square wave current provided from a drive.

FIG. 24 is a graph showing the torque per amp versus rotor angle for one revolution of the rotor of the first phase or A phase tandem motor element of FIG. 9 driven by a trapezoidal wave current provided from a drive.

FIG. 25 is a graph showing the torque per amp versus rotor angle for one revolution of the rotor of the second phase or B phase tandem motor element of FIG. 11 driven by a trapezoidal wave current provided from a drive.

FIG. 26 is a graph showing the torque per amp versus rotor angle for one revolution of the rotor of the third phase or C phase tandem motor element of FIG. 13 driven by a trapezoidal wave current provided from a drive.

### DETAILED DESCRIPTION

The invention shown in the Figures is generally directed to a tandem rotor servo motor assembly 100, and in particular a multi-phase servo motor 102 having a plurality of phase elements 110, 120, 130 mounted upon a common shaft 104. For ease of discussion and understanding, the following detailed description and illustrations refer to each phase element 110, 120, 130 of the multi-phase servo motor 102 as a permanent magnet motor. It should be appreciated that a permanent magnet motor is provided for purposes of illustration, and that the multi-phase servo motor 102 and associated phase elements 110, 120, 130 disclosed herein may be employed as a different type of motor, including, but not limited to, a reluctance motor or induction motor.

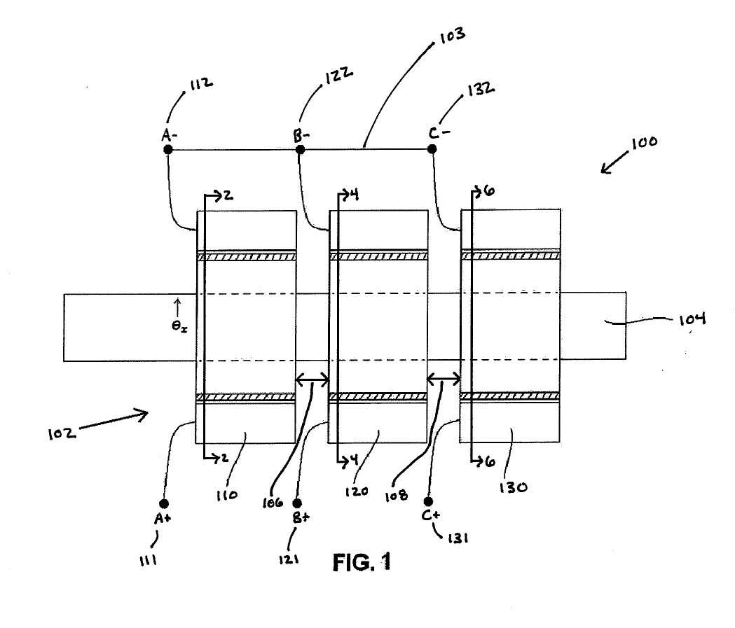

FIG. 1 is a plan view of an embodiment of a tandem rotor servo motor assembly 100. The tandem rotor servo motor assembly 100 generally includes a multi-phase servo motor 102. The multi-phase servo motor 102 includes three phases which are separated into three phase elements, a first or A phase element 110, a second or B phase element 120, and a third or C phase element 130. Each phase element 110, 120, 130 includes a respective input terminal connection or input lead 111, 121, 131, each of which corresponds to a phase of a three phase drive (not shown). An example of a three phase drive may include a DIGIFLEX® PERFORMANCE™ Series servo drive, Product Number DPRAHIE-030A800 available from ADVANCED MOTION CONTROLS® (located in Camarillo, Calif.). Each phase element 110, 120, 130 additionally includes a respective output terminal connection or output lead 112, 122, 132. Output terminal connections 112, 122, 132 are electrically connected by connector 103.

The multi-phase servo motor 102 also includes a common shaft 104. Each phase element 110, 120, 130 is mounted on or connected to shaft 104. As shown in FIG. 1, when connected to shaft 104, each phase element 110, 120, 130 is spaced or separated from one another by a distance 106, 108. For example, the first phase element 110 is separated from the second phase element 120 by a first distance or gap or spacing 106. Similarly, the second phase element 120 is separated from the third phase element 130 by a second distance or gap or spacing 108.

The tandem rotor servo motor assembly 100 may also include a casing or heat shrink tube (not shown) which encases or surrounds the multi-phase servo motor 102, endbells (not shown), and bearings, bearing supports and/or associated bearing assemblies (not shown).

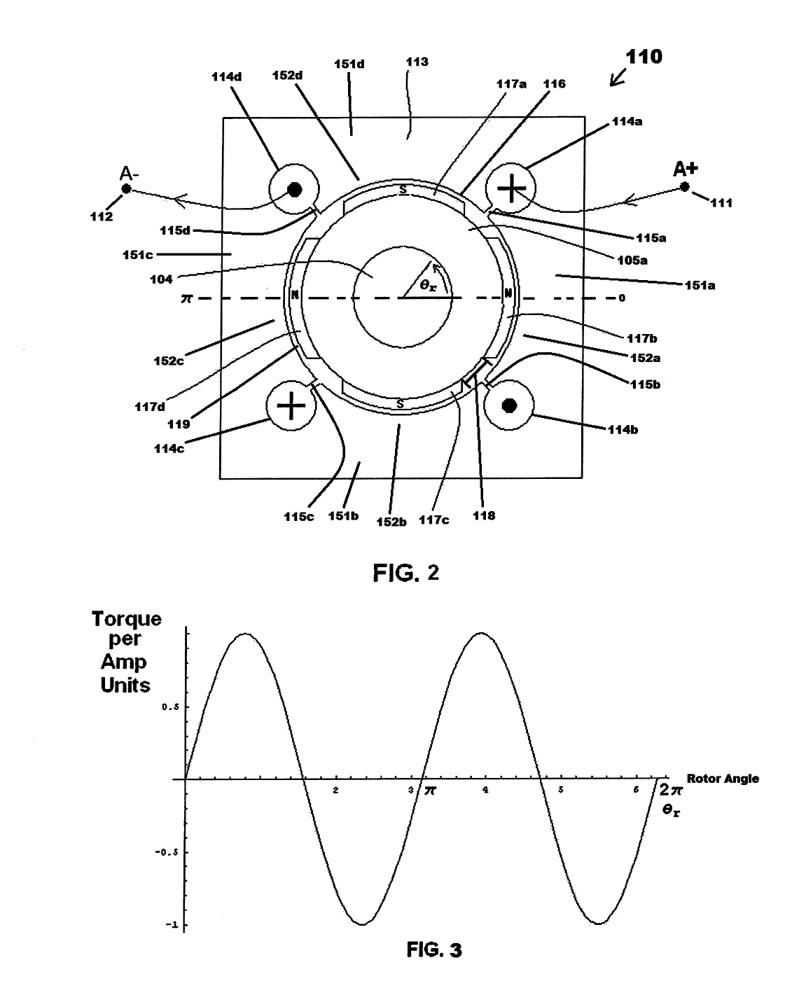

FIG. 2 illustrates a cross-sectional view of the first phase element 110. The first phase element 110 includes a stator or stator lamination 113. While one stator lamination 113 is shown, the first phase element 110 may include a stack or series or plurality of stator laminations 113. Stator lamination 113 includes back iron 151. As illustrated in FIG. 2, stator lamination 113 may include a plurality of back iron segments 151. Back iron segment or first back iron 151a is provided in a region between corner slots 114a and 114b. Back iron segment or second back iron 151b is provided in a region between corner slots 114b and 114c. Back iron segment or third back iron 151c is provided in a region between corner slots 114c and 114d. Back iron segment or fourth back iron 151d is provided in a region between corner slots 114d and 114a. The stator lamination 113 and associated back iron segments 151 are illustrated in FIG. 2 as arranged in an approximate square shaped configuration. An approximate square shaped configuration provides advantages over standard circular stator lamination and back iron arrangements. An approximate square shaped configuration provides a greater or increased amount of back iron 151 in the stator lamination 113 than a standard circular stator lamination. This allows for an increased amount of conductive material to be placed in or about corner slots 114 than a standard circular stator lamination. In addition, the greater amount of back iron 151 provides for corner slots 114 to be larger in size, also allowing for an increased amount of conductive material to be placed in or about corner slots 114. Further, the greater amount of back iron 151 allows for corner slots 114 to be provided toward the corners of stator lamination 113, allowing for less heat build-up in the stator lamination 113 due to improved heat transfer or heat dissipation or cooling. In one or more examples of embodiments, the stator lamination 113 may be rectangular or any other polygonal arrangement which provides for an increased amount of back iron in the stator lamination 113 than a standard circular stator lamination. Stator lamination 113 may be formed from iron, a combination of iron and silicon, silicon steel, metallic alloys or by any other known and suitable materials, processes or methods.

The stator lamination 113 includes or defines a plurality of corner slots 114. The illustrated stator lamination 113 defines four corner slots 114a, 114b, 114c, 114d. Each corner slot 114 corresponds with one of four poles of the servo motor 102. Accordingly, the four corner slots 114a, 114b, 114c, 114d define a four pole concentrated winding. The four corner slots 114a, 114b, 114c, 114d are provided in an arrangement approximately orthogonal or perpendicular to one another. For example, as shown in FIG. 2, corner slot 114a is neighbored by corner slots 114b and 114d. Corner slots 114b and 114d are provided approximately orthogonal to corner slot 114a. To this end, the four corner slots 114a, 114b, 114c, 114d are provided in relation to one another to approximately form the corners of a square. Each corner slot 114a, 114b, 114c, 114d alternates with its neighboring corner slot between carrying an electrical current into the corner slot or carrying an electrical current out of the corner slot. As shown in FIG. 2, corner slots 114a and 114c carry an electrical current into the respective slots, which is illustrated by a “+” or plus, while corner slots 114b and 114d carry an electrical current out of the respective slots, which is illustrated by a “•” or dot. In addition, corner slot 114a receives the first input terminal connection 111, while the first output terminal connection 112 exits from corner slot 114d. In one or more examples of embodiments, corner slots 114 may be circular, square, rectangular, or any other polygonal arrangement or appropriate size to maximize conductive material or windings in accordance with the present invention.

The stator lamination 113 may include or define a slot opening or neck or passage 115. The illustrated stator lamination 113 defines four slot openings 115a, 115b, 115c, 115d. Each slot opening 115a, 115b, 115c, 115d is in communication with a respective corner slot 114a, 114b, 114c, 114d. The width of slot opening 115a, 115b, 115c, 115d is preferably narrower than the width of the respective corner slot 114a, 114b, 114c, 114d.

The stator lamination 113 may also include stator tooth or teeth 152. Stator teeth 152 may generally be provided between the respective slot openings 115. As illustrated in FIG. 2, stator tooth or first stator tooth 152a is provided in a region between slot openings 115a and 115b. Stator tooth or second stator tooth 152b is provided in a region between slot openings 115b and 115c. Stator tooth or third stator tooth 152c is provided in a region between slot openings 115c and 115d. Stator tooth or fourth stator tooth 152d is provided in a region between slot openings 115d and 115a.

The stator lamination 113 includes or defines a rotor aperture 116. The rotor aperture 116 is in communication with corner slots 114a, 114b, 114c, 114d, for example, as illustrated in FIG. 2, through slot openings 115a, 115b, 115c, 115d. In addition, rotor aperture 116 receives or surrounds shaft 104.

Within rotor aperture 116, shaft 104 carries rotor 105a. Mounted upon or connected to rotor 105a is a plurality of magnets 117. As illustrated in FIG. 2, rotor 105a carries four magnets 117a, 117b, 117c, 117d. Magnets 117a, 117b, 117c, 117d are respectively provided about a portion of the circumference of rotor 105a. Further, each neighboring magnet 117a, 117b, 117c, 117d alternates its exposed pole about the circumference of rotor 105a. For example, magnets 117a and 117c may expose a south pole, which is illustrated by an “S”, while magnets 117b and 117d may expose a north pole, which is illustrated by an “N”. Magnets 117a, 117b, 117c, 117d are spaced apart from each respective neighboring magnet by a distance 118. The shaft 104 and associated rotor 105a and magnets 117a, 117b, 117c, 117d are spaced a distance from rotor aperture 116 by an air gap 119. The air gap 119 enables the shaft 104, rotor 105a and magnets 117a, 117b, 117c, 117d to rotate unobstructed within rotor aperture 116. As observed from the cross-sectional view of FIG. 2, the shaft 104, rotor 105a and magnets 117a, 117b, 117c, 117d rotate counter-clockwise within rotor aperture 116. In one or more examples of embodiments, magnets 117 may include straight cut edges, as illustrated in FIGS. 2, 4 and 6. In one or more examples of embodiments, magnets 117 may include angled edges, tapered edges, or any suitable edge for operation of the motor assembly 100 in accordance with the present invention. Further, in one or more examples of embodiments, distance 118 may be any suitable distance appropriate for the end use of the motor assembly 100 in accordance with the present invention.

FIG. 3 illustrates a graphical representation of the torque per amp (X-axis) versus the angle of rotation of the rotor, θᵣ (Y-axis) for one revolution of rotor 105a about the periphery of the air gap 119 of the first phase element 110. The torque per amp versus rotor angle of the first phase element 110 is in the shape of a sinusoidal curve. Based upon the four magnetic poles of the first phase element 110, the torque per amp versus rotor angle completes two electrical cycles for every one revolution of rotor 105a. The first electrical cycle is completed at 180° (one-hundred and eighty degrees) or t (pie) radians of rotation of rotor 105a, while the second electrical cycle is completed at 360° (three-hundred and sixty degrees) or 2π (two pie) radians of rotation of rotor 105a.

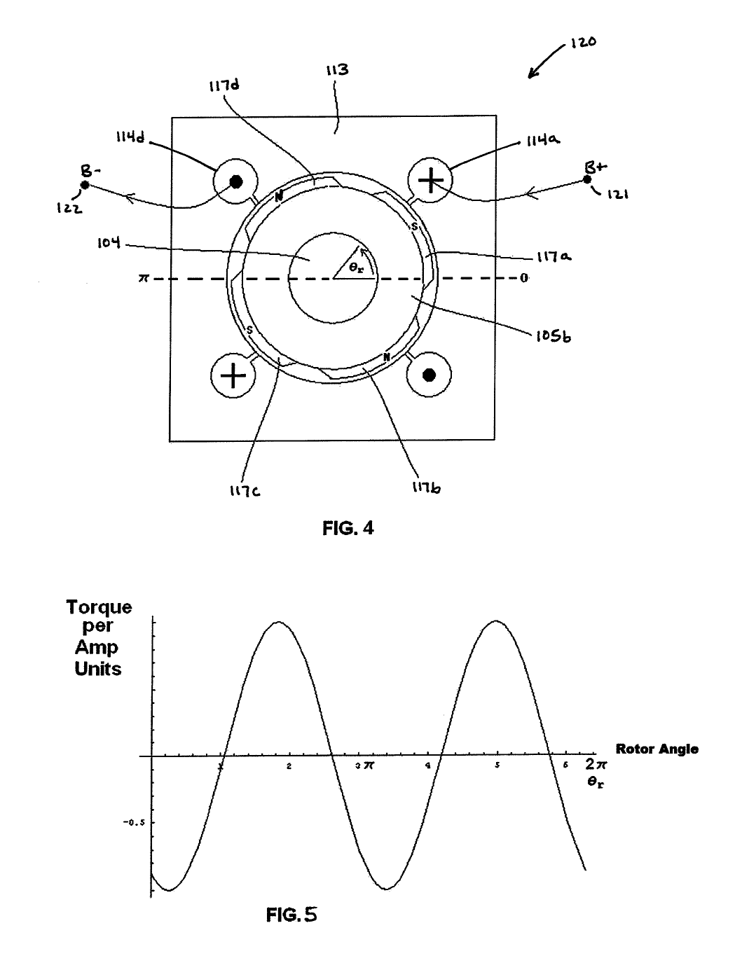

FIG. 4 illustrates a cross-sectional view of a cross section of the second phase element 120 of tandem rotor servo motor assembly 100. The second phase element 120 includes a stator lamination 113, corner slots 114, slot openings 115, rotor aperture 116, magnets 117, distance between magnets 118, air gap 119, back iron 151 and stator teeth 152 which are substantially as described herein in association with the first phase element 110. Operation and particular components described herein are substantially the same and like numbers have been used to illustrate the like components. Corner slot 114a of the second phase element 120 receives the second input terminal connection 121, while the second output terminal connection 122 exits from corner slot 114d. Within the rotor aperture 116 of the second phase element 120, common shaft 104 carries rotor 105b. Mounted upon or connected to rotor 105b is a plurality of magnets 117. As illustrated in FIG. 4, rotor 105b carries four magnets 117a, 117b, 117c, 117d. Rotor 105b is substantially the same as rotor 105a, but for the positioning of rotor 105b in relation to rotor 105a on shaft 104. Rotor 105b is provided on shaft 104 approximately 60° (sixty degrees) mechanically lagging from rotor 105a. In other words, comparing the cross-sectional view of the first phase element 110 of FIG. 2 to the cross-sectional view of the second phase element 120 of FIG. 4, rotor 105b (and the associated magnets 117) is illustrated as offset from rotor 105a (and the associated magnets 117) by approximately 60° (sixty degrees) lagging. Put differently, according to the illustrated view of FIG. 4, rotor 105b (and the associated magnets 117) is disposed about shaft 104 approximately 60° (sixty degrees) in the clockwise direction as compared to rotor 105a (of FIG. 2), as FIGS. 2 and 4 illustrate the rotation of shaft 104 as in the counter-clockwise direction. In addition to rotor 105b mechanically lagging rotor 105a by approximately 60° (sixty degrees), rotor 105b has an electrical angle which is lagging rotor 105a by approximately 120° (one hundred and twenty degrees). The associated electrical angle of rotor 105b can be calculated by multiplying the mechanical angle by N, where N equals the number of pole pairs (or one-half the total number of poles).

FIG. 5 illustrates a graphical representation of the torque per amp (X-axis) versus the angle of rotation of the rotor, θᵣ (Y-axis) for one revolution of rotor 105b about the periphery of the air gap 119 of the second phase element 120. The torque per amp versus rotor angle of the second phase element 120 is in the shape of a sinusoidal curve. Based upon the four magnetic poles of the second phase element 120, the torque per amp versus rotor angle completes two electrical cycles for every one revolution of rotor 105b. The first electrical cycle is completed at 180° (one-hundred and eighty degrees) or π (pie) radians of rotation of rotor 105b, while the second electrical cycle is completed at 360° (three-hundred and sixty degrees) or 2π (two pie) radians of rotation of rotor 105b. Comparing torque per amp versus rotor angle of FIG. 5 to FIG. 3, the torque per amp of FIG. 5 is shifted 60° (sixty degrees) mechanically lagging to the torque per amp of FIG. 3. In other words, the torque per amp curve of FIG. 5 is shifted π/3 radians to the right as compared to the torque per amp curve of FIG. 3. This is due to rotor 105b being rotated about shaft 104 60° (sixty degrees) behind, or lagging, rotor 105a.

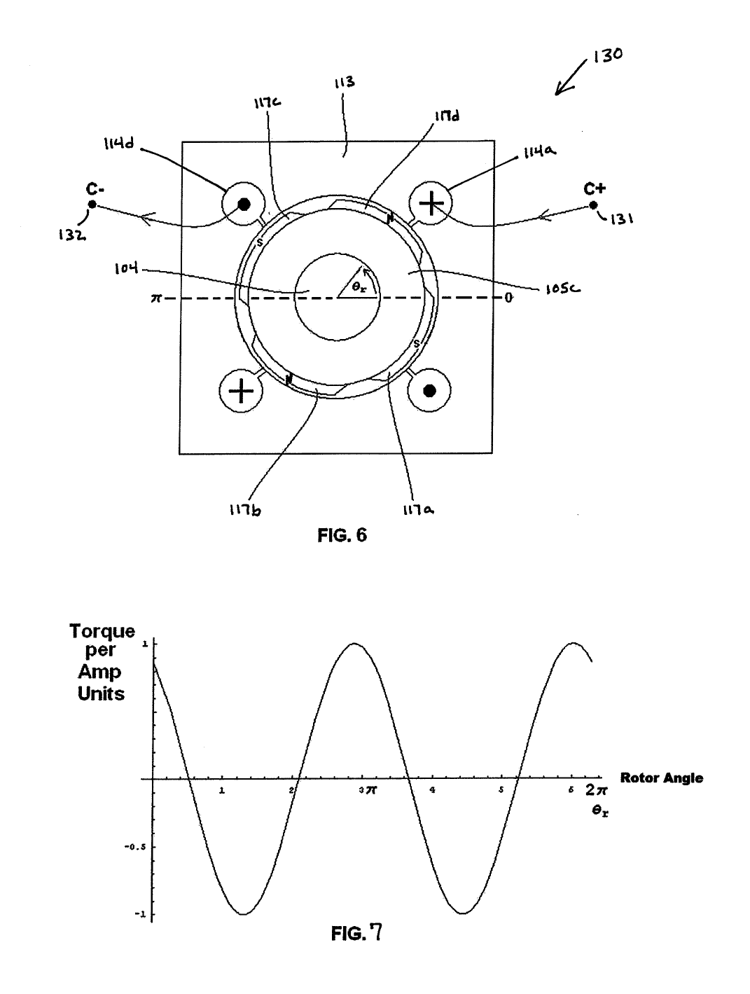

FIG. 6 illustrates a cross-sectional view of a cross section of the third phase element 130 of tandem rotor servo motor assembly 100. The third phase element 130 includes a stator lamination 113, corner slots 114, slot openings 115, rotor aperture 116, magnets 117, distance between magnets 118, air gap 119, back iron 151 and stator teeth 152, which are substantially as described herein in association with the first phase element 110. Operation and particular components described herein are substantially the same and like numbers have been used to illustrate the like components. Corner slot 114a of the third phase element 130 receives the third input terminal connection 131, while the third output terminal connection 132 exits from corner slot 114d. Within the rotor aperture 116 of the third phase element 130, common shaft 104 carries rotor 105c. Mounted upon or connected to rotor 105c is a plurality of magnets 117. As illustrated in FIG. 6, rotor 105c carries four magnets 117a, 117b, 117c, 117d. Rotor 105c is substantially the same as rotor 105a, but for the positioning of rotor 105c in relation to rotor 105a on shaft 104. Rotor 105c is provided on shaft 104 approximately 120° (one hundred and twenty degrees) mechanically lagging from rotor 105a. In other words, comparing the cross-sectional view of the first phase element 110 of FIG. 2 to the cross-sectional view of the third phase element 130 of FIG. 6, rotor 105c (and the associated magnets 117) is illustrated as offset from rotor 105a (and the associated magnets 117) by approximately 120° (one hundred and twenty degrees) lagging. Put differently, according to the illustrated view of FIG. 6, rotor 105c (and the associated magnets 117) is disposed about shaft 104 approximately 120° (one hundred and twenty degrees) in the clockwise direction as compared to rotor 105a (of FIG. 2), as FIGS. 2 and 6 illustrate the rotation of shaft 104 as in the counter-clockwise direction. In addition to rotor 105c mechanically lagging rotor 105a by approximately 120° (one hundred and twenty degrees), rotor 105c has an electrical angle which is lagging rotor 105a by approximately 240° (two hundred and forty degrees).

FIG. 7 illustrates a graphical representation of the torque per amp (X-axis) versus the angle of rotation of the rotor, θᵣ (Y-axis) for one revolution of rotor 105c about the periphery of the air gap 119 of the third phase element 130. The torque per amp versus rotor angle of the third phase element 130 is in the shape of a sinusoidal curve. Based upon the four magnetic poles of the third phase element 130, the torque per amp versus rotor angle completes two electrical cycles for every one revolution of rotor 105c. The first electrical cycle is completed at 180° (one-hundred and eighty degrees) or π (pie) radians of rotation of rotor 105c, while the second electrical cycle is completed at 360° (three-hundred and sixty degrees) or 2π (two pie) radians of rotation of rotor 105c. Comparing torque per amp versus rotor angle of FIG. 7 to FIG. 3, the torque per amp of FIG. 7 is shifted 120° (one hundred and twenty degrees) mechanically lagging to the torque per amp of FIG. 3. In other words, the torque per amp curve of FIG. 7 is shifted 2π/3 radians to the right as compared to the torque per amp curve of FIG. 3. This is due to rotor 105c being rotated about shaft 104 120° (one hundred and twenty degrees) behind, or lagging, rotor 105a.

An alternative embodiment of the tandem rotor servo motor assembly 200 is shown in FIGS. 8-14. The tandem rotor servo motor assembly 200 includes features which are substantially as described herein in association with the tandem rotor servo motor assembly 100. Operation and particular components described herein are substantially the same and like numbers have been used to illustrate the like components. Referring to FIG. 8, in this embodiment, the multi-phase servo motor 102 includes three phases which are separated into three phase elements, a first or A phase element 210, a second or B phase element 220, and a third or C phase element 230.

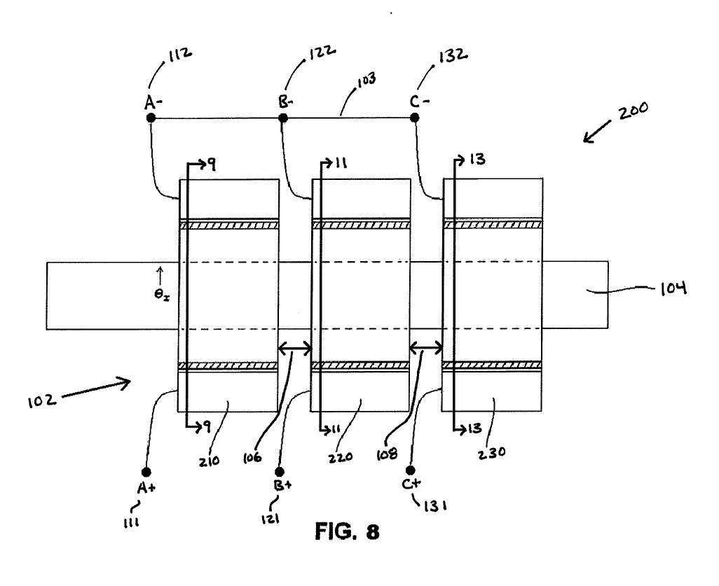

FIG. 9 illustrates a cross-sectional view of a cross section of the first phase element 210 of tandem rotor servo motor assembly 200. The first phase element 210 includes a stator lamination 113, corner slots 114, slot openings 115, rotor aperture 116, air gap 119, back iron 151 and stator teeth 152, which are substantially as described herein in association with the first phase element 110. Operation and particular components described herein are substantially the same and like numbers have been used to illustrate the like components. Within the rotor aperture 116 of the first phase element 210, common shaft 104 carries rotor 105a. Mounted upon or connected to rotor 105a is a plurality of magnets 217. As illustrated in FIG. 9, rotor 105a carries four magnets 217a, 217b, 217c, 217d. Magnets 217 are substantially as described herein in association with magnets 117, but for how magnets 217 are provided about a portion of the circumference of rotor 105a. As illustrated in FIG. 9, magnets 217a, 217b, 217c, 217d are provided about the circumference of rotor 105a such that each neighboring magnet 217a, 217b, 217c, 217d alternates its exposed pole. For example, magnets 217a and 217c may expose a south pole, which is illustrated by an “S”, while magnets 217b and 217d may expose a north pole, which is illustrated by an “N”. Further, magnets 217a, 217b, 217c, 217d abut or border or communicate with each respective neighboring magnet 217. To this end, magnets 217a, 217b, 217c, 217d are the same thickness radially outward from shaft 104. In other words, magnets 217a, 217b, 217c, 217d have the same or a uniform or a continuous thickness about the circumference of rotor 105a within air gap 119. As observed from the cross-sectional view of FIG. 9, the shaft 104, rotor 105a and magnets 217a, 217b, 217c, 217d rotate counter-clockwise within rotor aperture 116.

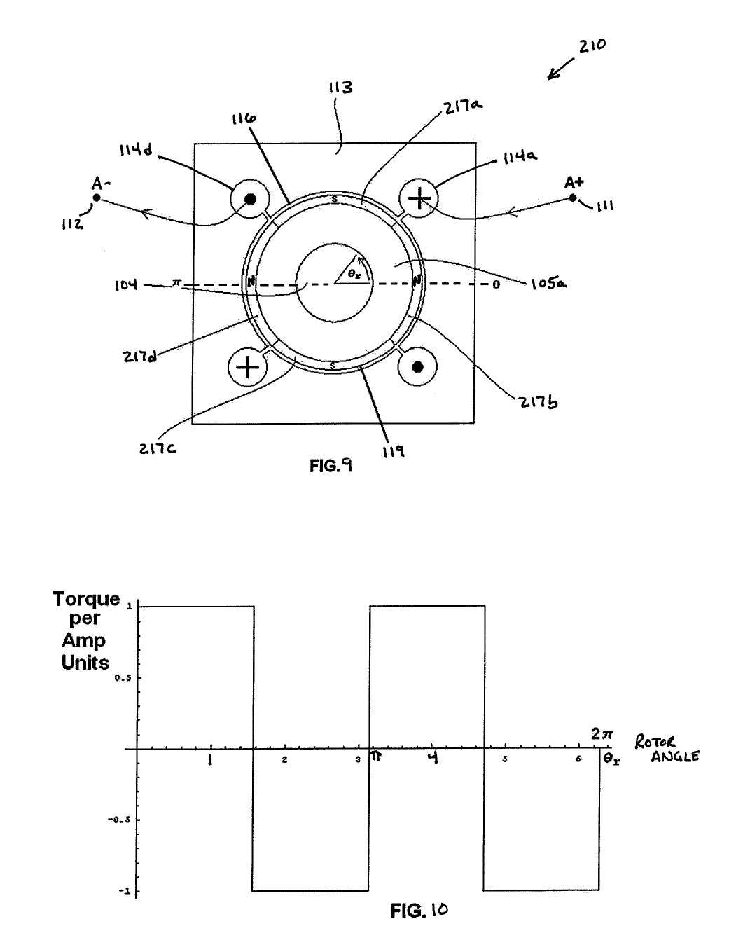

FIG. 10 illustrates a graphical representation of the torque per amp (X-axis) versus the angle of rotation of the rotor, θᵣ (Y-axis) for one revolution of rotor 105a about the periphery of the air gap 119 of the first phase element 210. The torque per amp versus rotor angle of the first phase element 210 is in the shape of a square wave. The square wave is generated by the continuous uniform thickness of magnets 217 about rotor 105a in air gap 119. Based upon the four magnetic poles of the first phase element 210, the torque per amp versus rotor angle completes two electrical cycles for every one revolution of rotor 105a. The first electrical cycle is completed at 180° (one-hundred and eighty degrees) or it (pie) radians of rotation of rotor 105a, while the second electrical cycle is completed at 360° (three-hundred and sixty degrees) or 2π (two pie) radians of rotation of rotor 105a.

FIG. 11 illustrates a cross-sectional view of a cross section of the second phase element 220 of tandem rotor servo motor assembly 200. The second phase element 220 includes substantially the same features which are substantially as described herein in association with the first phase element 210. Operation and particular components described herein are substantially the same and like numbers have been used to illustrate the like components. Corner slot 114a of the second phase element 220 receives the second input terminal connection 121, while the second output terminal connection 122 exits from corner slot 114d. Within the rotor aperture 116 of the second phase element 220, common shaft 104 carries rotor 105b. Mounted upon or connected to rotor 105b is a plurality of magnets 217. As illustrated in FIG. 11, rotor 105b carries four magnets 217a, 217b, 217c, 217d. Rotor 105b is substantially the same as rotor 105a, but for the positioning of rotor 105b in relation to rotor 105a on shaft 104. Rotor 105b is provided on shaft 104 approximately 60° (sixty degrees) mechanically lagging from rotor 105a. In other words, comparing the cross-sectional view of the first phase element 210 of FIG. 9 to the cross-sectional view of the second phase element 220 of FIG. 11, rotor 105b (and the associated magnets 217) is illustrated as offset from rotor 105a (and the associated magnets 217) by approximately 60° (sixty degrees) lagging. Put differently, according to the illustrated view of FIG. 11, rotor 105b (and the associated magnets 217) is disposed about shaft 104 approximately 60° (sixty degrees) in the clockwise direction as compared to rotor 105a (of FIG. 9), as FIGS. 9 and 11 illustrate the rotation of shaft 104 as in the counter-clockwise direction. In addition to rotor 105b mechanically lagging rotor 105a by approximately 60° (sixty degrees), rotor 105b has an electrical angle which is lagging rotor 105a by approximately 120° (one hundred and twenty degrees).

FIG. 12 illustrates a graphical representation of the torque per amp (X-axis) versus the angle of rotation of the rotor, θᵣ (Y-axis) for one revolution of rotor 105b about the periphery of the air gap 119 of the second phase element 220. The torque per amp versus rotor angle of the second phase element 220 is in the shape of a square wave. Based upon the four magnetic poles of the second phase element 220, the torque per amp versus rotor angle completes two electrical cycles for every one revolution of rotor 105b. The first electrical cycle is completed at 180° (one-hundred and eighty degrees) or π (pie) radians of rotation of rotor 105b, while the second electrical cycle is completed at 360° (three-hundred and sixty degrees) or 2π (two pie) radians of rotation of rotor 105b. Comparing torque per amp versus rotor angle of FIG. 12 to FIG. 10, the torque per amp of FIG. 12 is shifted 60° (sixty degrees) mechanically lagging to the torque per amp of FIG. 10. In other words, the torque per amp curve of FIG. 12 is shifted π/3 radians to the right as compared to the torque per amp curve of FIG. 10. This is due to rotor 105b being rotated about shaft 104 60° (sixty degrees) behind, or lagging, rotor 105a.

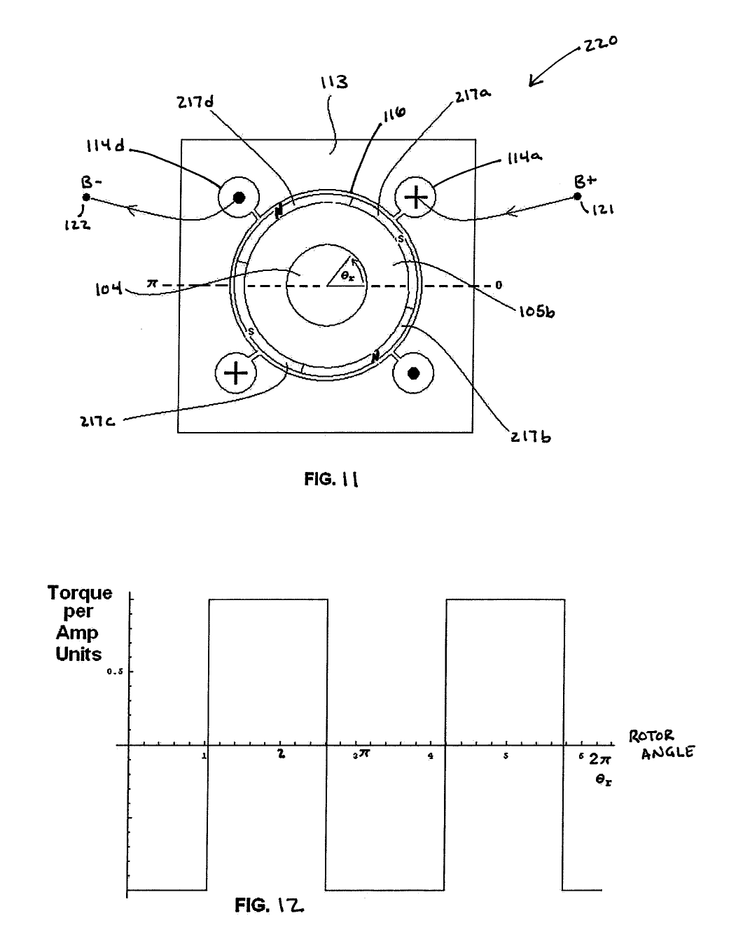

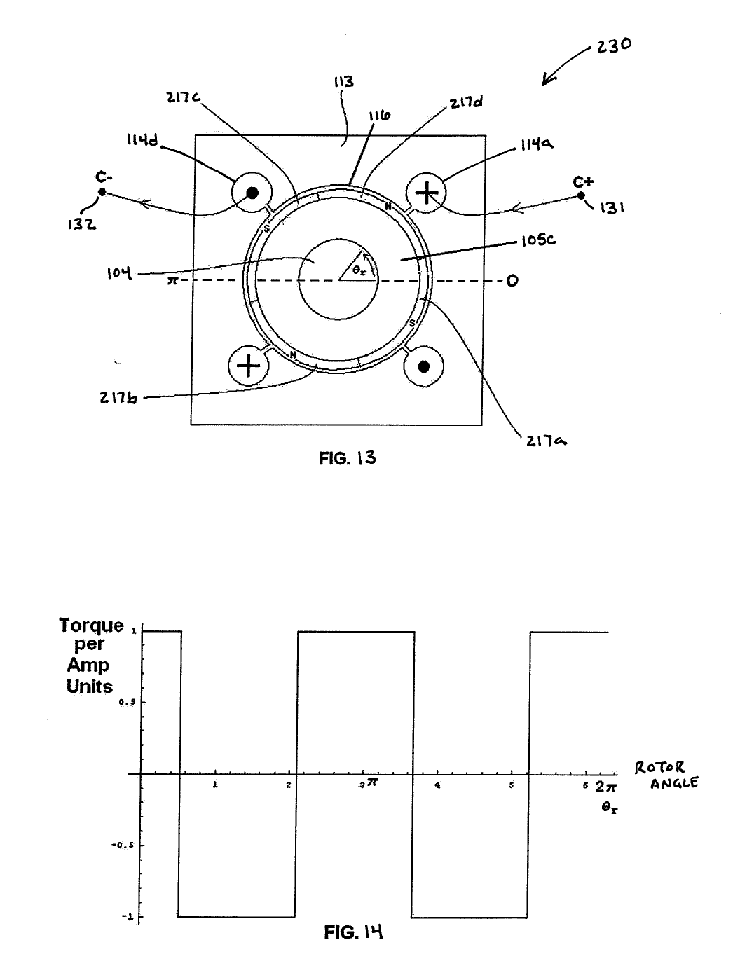

FIG. 13 illustrates a cross-sectional view of a cross section of the third phase element 230 of tandem rotor servo motor assembly 200. The third phase element 230 includes substantially the same features which are substantially as described herein in association with the first phase element 210. Operation and particular components described herein are substantially the same and like numbers have been used to illustrate the like components. Corner slot 114a of the third phase element 230 receives the third input terminal connection 131, while the third output terminal connection 132 exits from corner slot 114d. Within the rotor aperture 116 of the third phase element 230, common shaft 104 carries rotor 105c. Mounted upon or connected to rotor 105c is a plurality of magnets 217. As illustrated in FIG. 13, rotor 105c carries four magnets 217a, 217b, 217c, 217d. Rotor 105c is substantially the same as rotor 105a, but for the positioning of rotor 105c in relation to rotor 105a on shaft 104. Rotor 105c is provided on shaft 104 approximately 120° (one hundred and twenty degrees) mechanically lagging from rotor 105a. In other words, comparing the cross-sectional view of the first phase element 210 of FIG. 9 to the cross-sectional view of the third phase element 230 of FIG. 13, rotor 105c (and the associated magnets 217) is illustrated as offset from rotor 105a (and the associated magnets 217) by approximately 120° (one hundred and twenty degrees) lagging. Put differently, according to the illustrated view of FIG. 13, rotor 105c (and the associated magnets 217) is disposed about shaft 104 approximately 120° (one hundred and twenty degrees) in the clockwise direction as compared to rotor 105a (of FIG. 9), as FIGS. 9 and 13 illustrate the rotation of shaft 104 as in the counter-clockwise direction. In addition, to rotor 105c mechanically lagging rotor 105a by approximately 120° (one hundred and twenty degrees), rotor 105c has an electrical angle which is lagging rotor 105a by approximately 240° (two hundred and forty degrees).

FIG. 14 illustrates a graphical representation of the torque per amp (X-axis) versus the angle of rotation of the rotor, θᵣ (Y-axis) for one revolution of rotor 105c about the periphery of the air gap 119 of the third phase element 230. The torque per amp versus rotor angle of the third phase element 230 is in the shape of a square wave. Based upon the four magnetic poles of the third phase element 230, the torque per amp versus rotor angle completes two electrical cycles for every one revolution of rotor 105c. The first electrical cycle is completed at 180° (one-hundred and eighty degrees) or a (pie) radians of rotation of rotor 105c, while the second electrical cycle is completed at 360° (three-hundred and sixty degrees) or 2π (two pie) radians of rotation of rotor 105c. Comparing torque per amp versus rotor angle of FIG. 14 to FIG. 10, the torque per amp of FIG. 14 is shifted 120° (one hundred and twenty degrees) mechanically lagging to the torque per amp of FIG. 10. In other words, the torque per amp curve of FIG. 14 is shifted 2π/3 radians to the right as compared to the torque per amp curve of FIG. 10. This is due to rotor 105c being rotated about shaft 104 120° (one hundred and twenty degrees) behind, or lagging, rotor 105a.

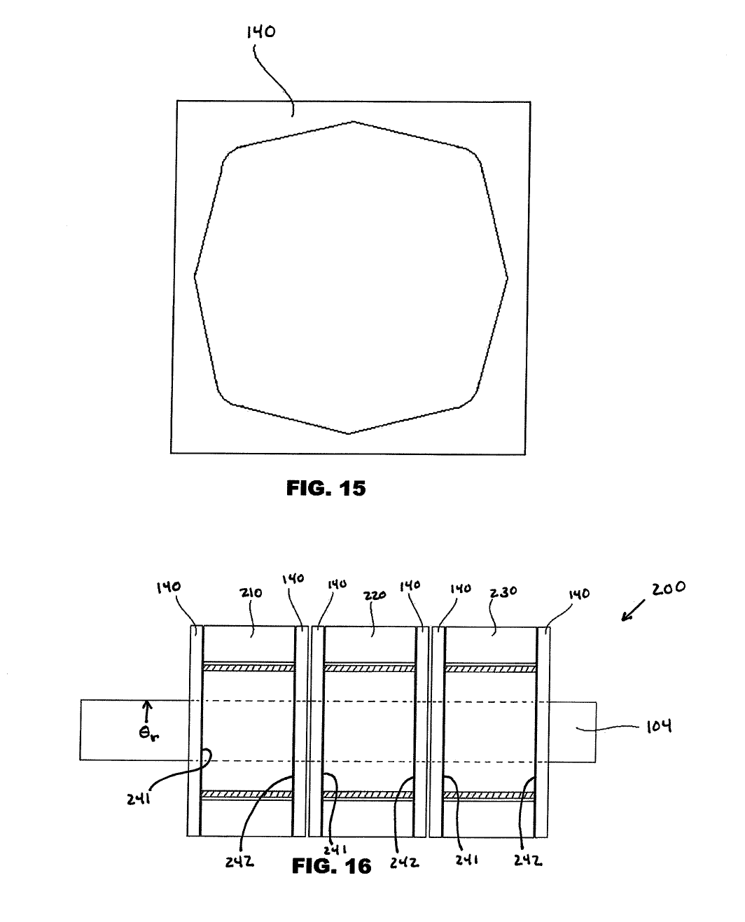

FIG. 15 illustrates an embodiment of a back iron lamination ring 140. The ring 140 advantageously provides greater surface area for conduction of the magnetic field in the stator. By providing greater surface area for conduction, the ring 140 prevents the stator back iron from magnetically saturating. Saturation of the stator back iron decreases the magnetic field and reduces torque. In one or more examples of embodiments, the ring 140 may be provided with a geometry or associated shape to maximize surface area of a motor assembly 100 stator in accordance with the present invention.

FIG. 16 illustrates an example of placement of a plurality of lamination rings 140 in association with an embodiment of a tandem rotor servo motor assembly 200. Each phase element 210, 220, 230 may respectively include a pair of lamination rings 140. As illustrated, lamination rings 140 may be connected to or attached to or affixed on faces 240 of each phase element 210, 220, 230, for example by, but not limited to, bolt or adhesive. Faces 240 may include a first edge face 241 and a second edge face 242. Edge faces 241, 242 and the associated lamination rings 140 are provided approximately perpendicular to common shaft 104.

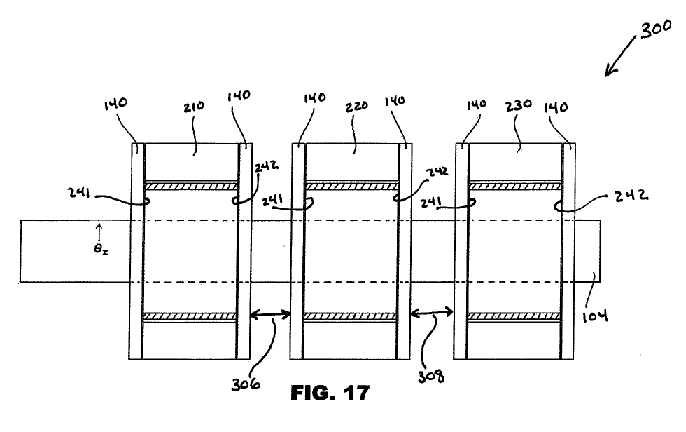

FIG. 17 illustrates an alternative embodiment of a tandem rotor servo motor assembly 300. The tandem rotor servo motor assembly 300 includes features which are substantially as described herein in association with the tandem rotor servo motor assembly 200. Operation and particular components described herein are substantially the same and like numbers have been used to illustrate the like components. Referring to FIG. 17, in this embodiment, the first, second, and third phase elements 210, 220, 230 include lamination rings 140 provided perpendicular to common shaft 104 and attached to edge faces 241, 242 of each phase element 210, 220, 230. In addition, when connected to shaft 104, each phase element 210, 220, 230 is spaced or separated from one another by a distance 306, 308. For example, the first phase element 210 is separated from the second phase element 220 by a first distance or gap or spacing 306. Similarly, the second phase element 220 is separated from the third phase element 230 by a second distance or gap or spacing 308. Distances 306, 308 may be greater than distances 106, 108 of FIG. 1. Phase elements 210, 220, 230 may be spaced a distance 306, 308 apart on shaft 104, advantageously providing more surface area for the cooling of each phase element 210, 220, 230. Further, spacing phase elements 210, 220, 230 a distance 306, 308 apart on shaft 104 does not substantially increase the inertia of the tandem rotor servo motor assembly 300. Accordingly, in one or more examples of embodiments, spacing phase elements 210, 220, 230 a distance 306, 308 from one another may lead to an increase in torque to inertia ratio. Electrical current transmitted through windings generates heat. Providing more surface area for the cooling of each phase element 210, 220, 230 dissipates heat generated by the windings. Consequently, more electrical current can be transmitted through the windings, increasing the torque output, without burning out the windings of the motor.

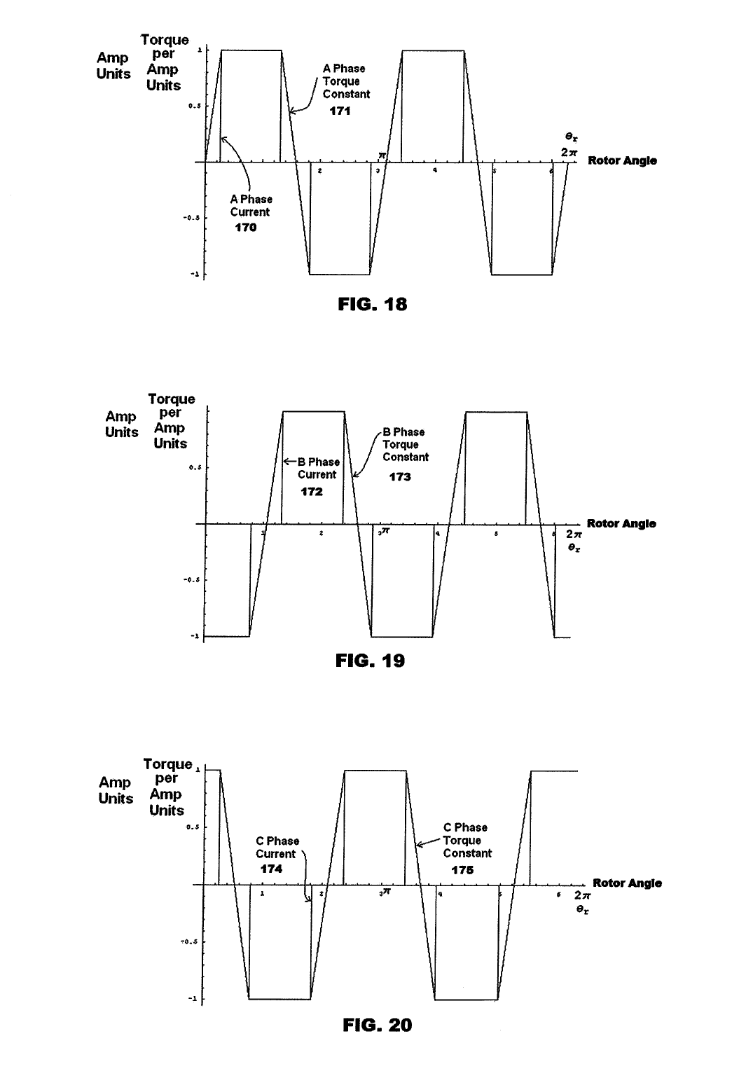

FIG. 18 illustrates a graphical representation of the torque per amp (X-axis) versus the angle of rotation of a rotor, θᵣ (Y-axis) for one revolution of a rotor in the A phase or first phase of a conventional single stator, single rotor multi-phase motor. The A phase current 170 is illustrated as a conventional square wave current provided from a drive. The A phase torque constant 171 is a trapezoidal wave form. FIG. 19 illustrates a graphical representation of the torque per amp (X-axis) versus the angle of rotation of a rotor, θᵣ (Y-axis) for one revolution of a rotor in the B phase or second phase of a conventional single stator, single rotor multi-phase motor. The B phase current 172 is illustrated as a conventional square wave current provided from a drive, while the B phase torque constant 173 is a trapezoidal wave form. FIG. 20 illustrates a graphical representation of the torque per amp (X-axis) versus the angle of rotation of a rotor, θᵣ (Y-axis) for one revolution of a rotor in the C phase or third phase of a conventional single stator, single rotor multi-phase motor. The C phase current 174 is illustrated as a conventional square wave current provided from a drive, while the C phase torque constant 175 is a trapezoidal wave form. The trapezoidal wave forms of the A, B and C phase torque constants 171, 173, 175 is generated from the configuration of the stator windings of a conventional multi-phase motor. The stator windings of each phase are wound about a single stator. Accordingly, the winding phases generate interference with one another. The interference leads to the trapezoidal shaped torque constant. The trapezoidal wave forms of the A, B and C torque constants 171, 173, 175 leads to undesired torque ripple. Should any of the A, B, or C phases 170, 172, 174 shift out of phase with one another, torque ripple will occur.

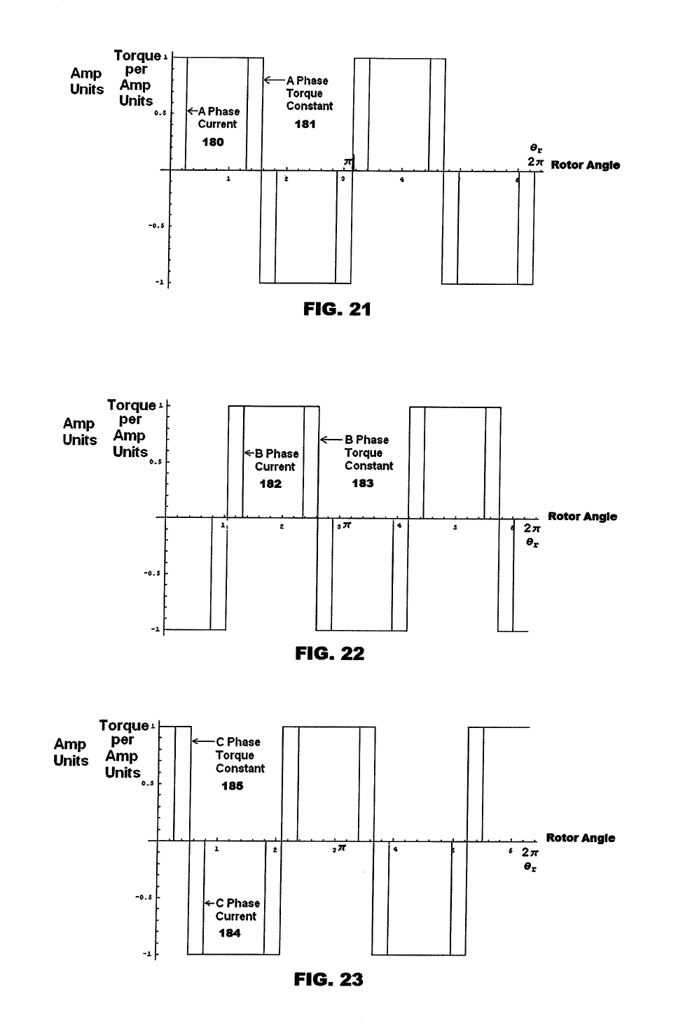

FIG. 21 illustrates a graphical representation of the torque per amp (X-axis) versus the angle of rotation of a rotor, θᵣ (Y-axis) for one revolution of rotor 105a in the A phase or first phase element 210 of the tandem rotor servo motor assembly 200. The A phase current 180 is illustrated as a conventional square wave current provided from a drive. The A phase torque constant 181 is a square wave form. FIG. 22 illustrates a graphical representation of the torque per amp (X-axis) versus the angle of rotation of a rotor, θᵣ (Y-axis) for one revolution of rotor 105b in the B phase or second phase element 220 of the tandem rotor servo motor assembly 200. The B phase current 182 is illustrated as a conventional square wave current provided from a drive, while the B phase torque constant 183 is a square wave form. FIG. 23 illustrates a graphical representation of the torque per amp (X-axis) versus the angle of rotation of a rotor, (Y-axis) for one revolution of rotor 105c in the C phase or third phase element 230 of the tandem rotor servo motor assembly 200. The C phase current 184 is illustrated as a conventional square wave current provided from a drive, while the C phase torque constant 185 is a square wave form. The square wave form of the A, B and C phase torque constants 181, 183, 185 is generated from the separated phase elements 210, 220, 230 of the tandem rotor servo motor assembly 200 as described herein. Separation of the phase elements 210, 220, 230 eliminates interference by other phases, allowing for the generation of a square wave form torque constant. The square wave form torque constants 181, 183, 185 are desired and advantageous, as should any of the A, B, or C phases 180, 182, 184 shift out of phase with one another, torque ripple will be minimized or not occur. For example, if any of the A, B, or C phases 180, 182, 184 shift out of phase by an electrical angle θ (theta), the torque output will not be reduced and no torque ripple will occur, as long as the electrical angle θ (theta) is less than 15° (fifteen degrees).

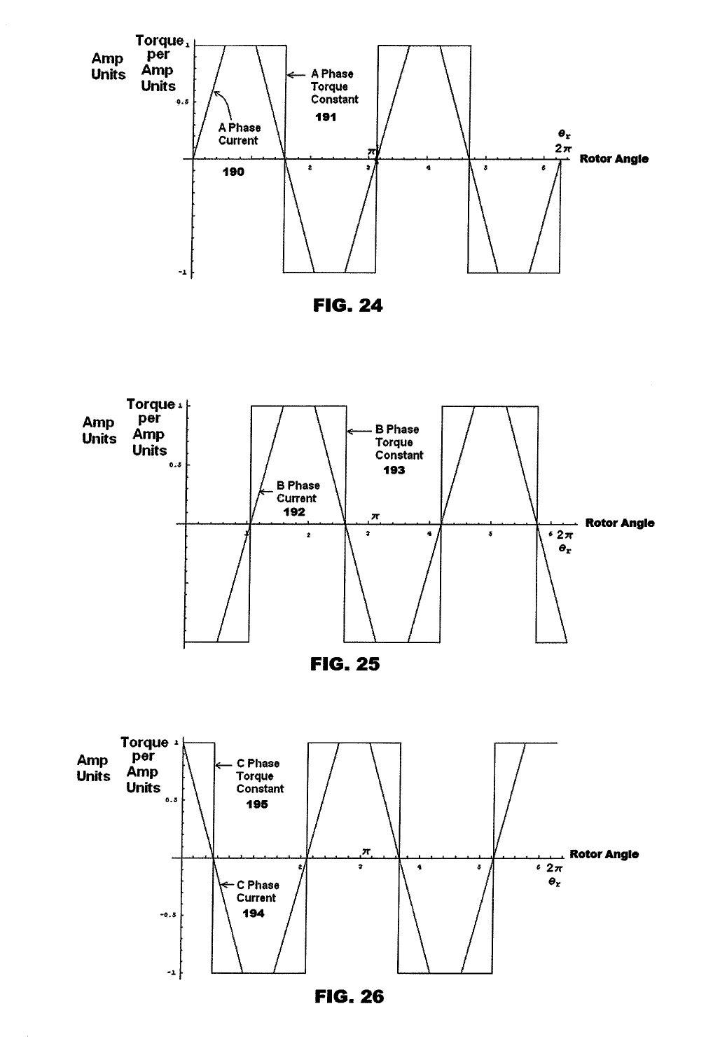

FIG. 24 illustrates a graphical representation of the torque per amp (X-axis) versus the angle of rotation of a rotor, θᵣ (Y-axis) for one revolution of rotor 105a in the A phase or first phase element 210 of the tandem rotor servo motor assembly 200. The A phase current 190 is illustrated as a conventional trapezoidal wave current provided from a drive. A trapezoidal wave current is preferred at higher motor or rotor speeds. The A phase torque constant 191 is a square wave form. FIG. 25 illustrates a graphical representation of the torque per amp (X-axis) versus the angle of rotation of a rotor, θᵣ (Y-axis) for one revolution of rotor 105b in the B phase or second phase element 220 of the tandem rotor servo motor assembly 200. The B phase current 192 is illustrated as a conventional trapezoidal current provided from a drive, while the B phase torque constant 193 is a square wave form. FIG. 23 illustrates a graphical representation of the torque per amp (X-axis) versus the angle of rotation of a rotor, θᵣ (Y-axis) for one revolution of rotor 105c in the C phase or third phase element 230 of the tandem rotor servo motor assembly 200. The C phase current 194 is illustrated as a conventional trapezoidal current provided from a drive, while the C phase torque constant 195 is a square wave form. The square wave form of the A, B and C phase torque constants 191, 193, 195 is generated from the separated phase elements 210, 220, 230 of the tandem rotor servo motor assembly 200 as described herein. Separation of the phase elements 210, 220, 230 eliminates interference by other phases, allowing for the generation of a square wave form torque constant. The square wave form torque constants 191, 193, 195 are desired and advantageous, as should any of the A, B, or C phases 190, 192, 194 shift out of phase with one another, torque ripple will be minimized over a conventional single stator, single rotor multi-phase motor. For example, if any of the A, B, or C phases 180, 182, 184 shift out of phase by an electrical angle θ (theta), a torque ripple will occur, however, will not be as severe as a conventional single stator, single rotor multi-phase motor for the same angle θ. In addition, the tandem rotor servo motor assembly 200 and associated A, B and C phase current waveforms 190, 192, 194 and torque constants 191, 193, 195 illustrated in FIGS. 24-26 eliminate a source of torque ripple present in conventional single stator, single rotor multi-phase motors. As illustrated in FIGS. 18-20, the drive of a conventional single stator, single rotor multi-phase motor is required to quickly produce the exact step current functions for the current waveforms 170, 172, 174. However, drives are unable to provide the exact step current functions fast enough, which causes torque ripple. The current waveforms 190, 192, 194 illustrated in FIGS. 24-26 do not change or transition quickly, eliminating the potential source of torque ripple.

There are several advantages to the tandem rotor servo motor assembly. The four pole square of each phase element allows for the fitting of more conductor material into the corner slots. This advantageously reduces the winding resistance and thus reduces the heat generated in the motor winding. Further, the amount of slot liner insulation will be significantly less than conventional single stator, single rotor multi-phase servo motors. Slot liner insulation is placed inside of a slot to separate conductor wires and avoid a short. By increasing the size of corner slots, more conductor wires may be placed in each slot. By providing more room for conductor material in the slots of each of the four poles, and accordingly more conductor wires than insulation in a slot, heat is reduced. In addition, the four pole arrangement lowers the electrical frequency at high shaft and rotor speeds than conventional servo motor designs incorporating six or more poles. Conventional servo motors typically utilize six or more poles to reduce the back iron and thus reduce the size of the motor. This results in reducing the rated continuous torque at higher speeds because of higher iron losses due to higher electrical frequencies by the increased poles/pole pairs. The four pole square tandem rotor servo motor assembly does not reduce the rating of continuous torque at high speeds as much as conventional motor designs because of the lower frequency iron losses. Further, the tandem rotor servo motor assembly has a better speed range than conventional servo motors. At high speeds, conventional servo motor drives will have to drive the inductance. This requires extra voltage to drive the inductance proportional to the electrical frequency. The four pole square tandem servo motor assembly has a lower electrical frequency at higher speeds than conventional servo motors incorporating six poles or more. This advantageously enables the tandem rotor servo motor assembly to reach a greater maximum speed than conventional servo motors and accordingly a greater speed range.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, coupled, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred embodiments, persons skilled in the art will recognize that changes may be made in form and detail without departing from the spirit and scope of the invention.

What is claimed is:

1. A tandem rotor servo motor assembly comprising:
a first phase element positioned on a shaft, the first phase element having a first rotor in communication with the shaft and surrounded by a stator carrying four magnetic poles, each of said poles exerting a magnetic force when said poles are electrically charged;
a second phase element positioned on the shaft a first distance from the first phase element, the second phase element having a second rotor in communication with the shaft and surrounded by a stator carrying four magnetic poles, each of said poles exerting a magnetic force when said poles are electrically charged;
a third phase element positioned on the shaft a second distance from the second phase element, the third phase element having a third rotor in communication with the shaft and surrounded by a stator carrying four magnetic poles, each of said poles exerting a magnetic force when said poles are electrically charged;
the second rotor being offset about the shaft from the first rotor by sixty degrees of rotation; and
the third rotor being offset about the shaft from the first rotor by one hundred and twenty degrees of rotation.

2. The tandem rotor servo motor assembly of claim 1, wherein the first, second and third rotors each include permanent magnets.

3. The tandem rotor servo motor assembly of claim 2, wherein the first, second and third rotors each include four permanent magnets.

4. The tandem rotor servo motor assembly of claim 3, wherein the permanent magnets of the second rotor are offset about the shaft from the permanent magnets of the first rotor by sixty degrees of rotation and the permanent magnets of the third rotor are offset about the shaft from the permanent magnets of the first rotor by one hundred and twenty degrees of rotation.

5. The tandem rotor servo motor assembly of claim 1, wherein the cross-section of the stator of the first, second and third phase elements is square in shape.

6. The tandem rotor servo motor assembly of claim 1 wherein the first, second and third phase elements each produce a square waveform torque constant.

7. The tandem rotor servo motor assembly of claim 1 further comprising at least one back iron lamination ring connected to a portion of at least one of the first phase element stator, the second phase element stator or the third phase element stator.

8. The tandem rotor servo motor assembly of claim 1, wherein the first phase element receives a first phase of three-phase electric current, the second phase element receives a second phase of three-phase electric current, and the third phase element receives a third phase of three-phase electric current.

9. A tandem rotor servo motor assembly comprising:
a multi-phase servo motor having a first phase element, a second phase element, and a third phase element, the first, second and third phase elements including a rotor and a stator carrying four magnetically charged poles, each pole exerting a magnetic force when said poles are electrically charged; and
a shaft connected to the rotors of the first, second and third phase elements, the second rotor is provided on the shaft π/3 radians offset from the first rotor, and the third rotor is provided on the shaft 2π/3 radians offset from the first rotor.

10. The tandem rotor servo motor assembly of claim 9, wherein the stators of the first, second and third phase elements have a square cross-sectional profile taken parallel to the axis of rotation of the shaft.

11. The tandem rotor servo motor assembly of claim 9, wherein the first, second and third phase elements respectively receive a separate phase of a three-phase electric current.

12. The tandem rotor servo motor assembly of claim 9, wherein the first phase element is spaced along the shaft a first distance from the second phase element, the second phase element is spaced along the shaft a second distance from the third phase element, and the first phase element is spaced along the shaft a third distance from the third phase element.

13. The tandem rotor servo motor assembly of claim 9, wherein the rotors of the first, second and third phase elements each include four permanent magnets, the four permanent magnets are provided about the rotor such that each magnet has an opposing pole as the neighboring magnet.

14. The tandem rotor servo motor assembly of claim 13, wherein the four permanent magnets of at least one of the first, second and third phase elements are provided about the rotor such that each magnet has a distance between the neighboring magnet.

15. The tandem rotor servo motor assembly of claim 9 wherein the first, second and third phase elements each produce a square waveform torque constant.

16. A tandem servo motor comprising:
a first phase element in communication with a shaft, the first phase element having a first rotor connected to the shaft and surrounded by a stator carrying four magnetic poles, each of said poles exerting a magnetic force when said poles are electrically charged by a first phase of a three-phase current, said first phase element producing a square waveform torque constant;
a second phase element in communication with the shaft a first distance from the first phase element, the second phase element having a second rotor connected to the shaft and surrounded by a stator carrying four magnetic poles, each of said poles exerting a magnetic force when said poles are electrically charged by a second phase of a three-phase current, said second phase element producing a square waveform torque constant;
a third phase element in communication with the shaft a second distance from the second phase element and a third distance from the first phase element, the third phase element having a third rotor connected to the shaft and surrounded by a stator carrying four magnetic poles, each of said poles exerting a magnetic force when said poles are electrically charged by a third phase of a three-phase current, said third phase element producing a square waveform torque constant;
the second rotor being offset about the shaft from the first rotor by approximately sixty degrees of rotation; and
the third rotor being offset about the shaft from the first rotor by approximately one hundred and twenty degrees of rotation and from the second rotor by approximately sixty degrees of rotation.

17. The tandem servo motor of claim 16, wherein the stators of the first, second and third phase elements have a square cross-sectional profile taken parallel to the axis of rotation of the shaft.

18. The tandem servo motor of claim 16, wherein the first, second and third rotors each include four permanent magnets provided about the circumference of the rotor.

19. The tandem servo motor of claim 18, wherein the permanent magnets of the second rotor are offset about the shaft from the permanent magnets of the first rotor by approximately sixty degrees of rotation and the permanent magnets of the third rotor are offset about the shaft from the permanent magnets of the first rotor by approximately one hundred and twenty degrees of rotation and from the second rotor by approximately sixty degrees of rotation.

20. The tandem servo motor of claim 16 further comprising at least one back iron lamination ring connected to a portion of at least one of a back iron of the first phase element stator, the second phase element stator or the third phase element stator.
